(19) United States
(12) Patent Application Publication
(10) Pub. No.: US 2013/0072352 A1
(43) Pub. Date: Mar. 21, 2013

(54) SPINE EXERCISE APPARATUS

(71) Applicants: KWANG WOOK JUNG, (US); HYOUNG GI PARK, (US)

(72) Inventors: KWANG WOOK JUNG, (US); HYOUNG GI PARK, (US)

(73) Assignee: MAN&TEL CO., LTD., GUMI-SI (KR)

(21) Appl. No.: 13/617,360

(22) Filed: Sep. 14, 2012

(30) Foreign Application Priority Data
Sep. 16, 2011 (KR) 10-2011-0093361

(51) Int. Cl. A63B 24/00; A63F 13/00

(52) U.S. Cl. 482/4; 463/31

(57) ABSTRACT

Disclosed herein is a spine exercise apparatus which makes it possible for a user to actively perform spine exercise in a variety of postures. The spine exercise apparatus includes a base plate, a support unit, a plate drive unit and a control box. The base plate includes body contact units which come into contact with portions of the user's body and support the user's body. The support unit protrudes from the base plate and supports another portion of the user's body. The plate drive unit supplies power to the plate so that the plate moves in a plurality of degrees of freedom. The control box creates a plate drive signal containing information about the power to be supplied by the plate drive unit and provides the plate drive signal to the plate drive unit.

### CROSS-REFERENCE TO RELATED PATENT APPLICATIONS

This application claims priority to Korean Patent Application No. 10-2011-0093361, filed Sep. 16, 2011.

### BACKGROUND OF THE INVENTION

1. Field of the Invention

The present invention relates generally to spine exercise apparatuses and, more particularly, to a spine exercise apparatus which makes it possible for a user to actively perform spine exercises in a variety of postures.

2. Description of the Related Art

Recently, the life styles of modern people who spend a lot of time sitting and have less time to exercise have increased the number of patients who have spinal pain. Particularly, as the population becomes older, the increase in the number of patients who have spinal pain is expected to continue.

As such, despite the increase in the number of patients who have spinal pain, up until now there have not been enough spinal exercise or treatment apparatuses. The greater part of treatment for spinal pain has been invasive surgery. Therefore, the increase in the number of patients who have spinal pain reduces the social or economically active population but increases the recuperation expenses. This thus becomes a problem at the national level.

The conventional spine exercise apparatuses that are being used are simple manual exercise apparatuses which have the purpose of guiding or massaging the spines of users. The target effects of treatment by these conventional apparatuses have not been established. Moreover, most of the conventional apparatuses which are being used for the purposes of treatment are expensive imported apparatuses, making it difficult for them to be widely used.

As the importance of rehabilitation treatment apparatuses has come to the fore, several organizations and corporations in the Republic of Korea have sporadically invested in research and development. However, to date, the number of commercialized spine exercise apparatuses is very small. Moreover, such conventional spine exercise apparatuses do not offer systematic and programmed treatment functions.

### SUMMARY OF THE INVENTION

Accordingly, the present invention has been made keeping in mind the above problems occurring in the prior art, and an object of the present invention is to provide a spine exercise apparatus which makes it possible for a user to actively perform spine exercises in a variety of postures.

In order to accomplish the above object, the present invention provides a spine exercise apparatus, including: a base plate provided with a plurality of body contact units coming into contact with portions of a body of a user, the base plate having an upper surface supporting the body of the user while the body contact units come into contact with the portions of the body of the user; a support unit protruding from the upper surface of the base plate, the support unit supporting another portion of the body of the user; a plate drive unit supplying power to the plate so that the plate moves in a plurality of degrees of freedom; and a control box creating a plate drive signal containing information about the power to be supplied by the plate drive unit and providing the plate drive signal to the plate drive unit.

Each of the body contact units may include a first load cell sensing a pressure applied from the corresponding portion of the body of the user that is brought into contact with the respective body contact unit.

The support unit may include: a lower support part protruding from the upper surface of the base plate; an upper support part provided on an upper end of the lower support part, the upper support part having a plurality of degrees of freedom; and a second load cell sensing a pressure applied from the portion of the body of the user that is supported by the upper support part.

The control box may include a gravity center calculating unit calculating a center of gravity of the body of the user using the pressures sensed by the first load cells and the second load cell.

The spine exercise apparatus may further include an electromyogram sensor attached to an erector muscle of the spine of the body of the user that is supported on the upper surface of the base plate, the electromyogram sensor sensing information about movement of the erector muscle of spine.

The control box may further include a gyro sensor attached to the base plate to sense a direction and degree in which the base plate is tilted.

The spine exercise apparatus may further include a spine condition determining unit determining information about conditions of the spine of the body of the user using the center of gravity of the body calculated by the gravity center calculating unit, the information about movement of the erector muscle of the spine sensed by the electromyogram sensor, and the direction and degree, in which the base plate is tilted, sensed by the gyro sensor.

The spine exercise apparatus may further include a display unit displaying the information about the conditions of the spine determined by the spine condition determining unit.

The control box may further include a feedback game output unit providing, using the display unit, a biofeedback game interlocked to the movement of the base plate operated by the plate drive unit depending on the information about the conditions of the spine determined by the spine condition determining unit.

The body contact units may comprise four body contact units coming into contact with hands and knees of the user such that the body of the user is supported on the base plate in a posture in which the user is on the hands and knees, and the support unit may support an abdomen of the user who is on the hands and knees.

The support unit may support hips of the user who is in a sitting posture, and the body contact unit may comprise two body contact units coming into contact with feet of the user so that the feet of the user who is sitting on the support unit are supported on the respective body contact units.

The plate drive unit may provide power to the base plate so that the base plate is operated in four degrees of freedom, and the upper support part may have four degrees of freedom.

As described above, in a spine exercise apparatus according to the present invention, a patient can actively perform spine training exercises or undergo treatment not only in an upright posture but also in a posture in which the patient is on his/her hands and knees. Therefore, the spine exercise apparatus can be applied to all of patients who have pain in their spines regardless of the extent of symptoms.

Furthermore, the spine exercise apparatus includes a support unit which supports a portion of the patient's body (e.g. the abdomen or hips). Thus, the distribution of the pressure transmitted from the patient's body can be checked more precisely. In addition, the support unit offers additional support for the patient's body so that the load applied to the spine during spine training exercises can be reduced.

Moreover, spine training exercises or treatment using the spine exercise apparatus according to the present invention can substitute for spinal surgery, thus reducing the time expense or financial cost for the patient, and, in addition, increasing the productive population at the national level.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view illustrating a spine exercise apparatus, according to an embodiment of the present invention;

FIG. 2 is a sectional view showing a body contact unit of the spine exercise apparatus of the embodiment of the present invention;

FIG. 3 is a view showing in detail a support unit of the spine exercise apparatus of the embodiment of the present invention;

FIG. 4 is a sectional view of the support unit of the spine exercise apparatus of the embodiment of the present invention;

FIG. 5 is a block diagram showing the construction of the spine exercise apparatus of the embodiment of the present invention;

FIG. 6 is a block diagram showing in detail the construction of a control box of the spine exercise apparatus of the embodiment of the present invention; and

FIG. 7 is a perspective view illustrating a spine exercise apparatus, according to another embodiment of the present invention.

### DESCRIPTION OF THE PREFERRED EMBODIMENTS

Hereinafter, preferred embodiments of the present invention will be described in detail with reference to the attached drawings. However, a variety of modifications of the embodiments of the present invention are possible, and the bounds of the present invention are not limited to the following embodiments. The embodiments of the present invention are provided only to enable those skilled in this art to more clearly understand the present invention. Furthermore, the terms and words used for elements in the description of the present invention have been selected in consideration of the functions that the elements have in the present invention. The terms and words may be changed depending on the intention or custom of those skilled in this art and must not be construed as limiting the elements of the present invention.

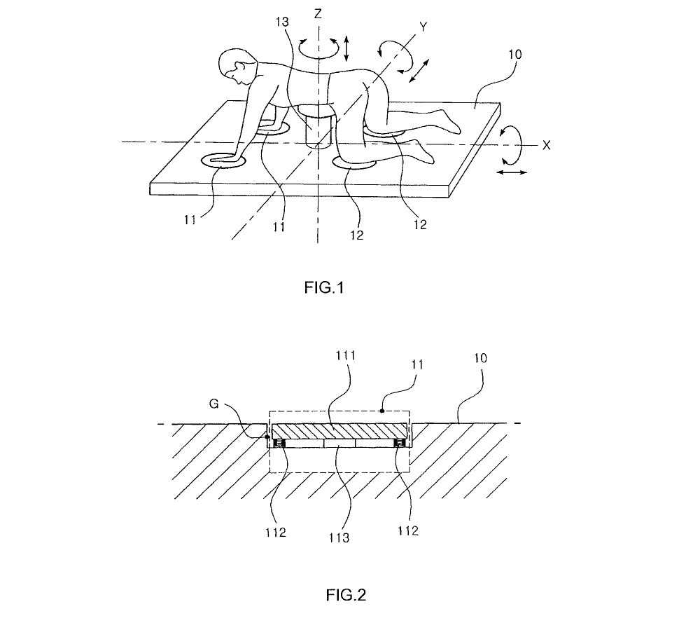

FIG. 1 is a perspective view illustrating a spine exercise apparatus, according to a preferred embodiment of the present invention. FIG. 5 is a block diagram illustrating the construction of the spine exercise apparatus of the embodiment of the present invention.

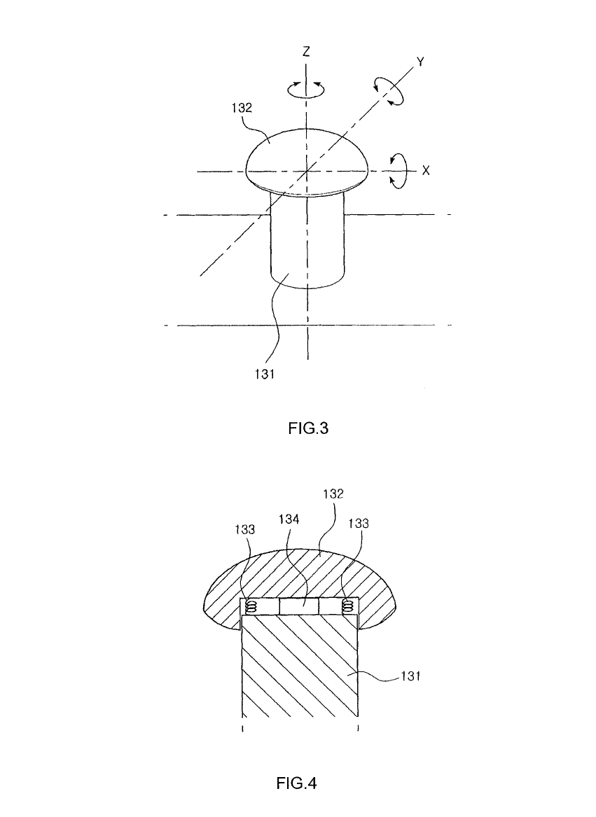

Referring to FIGS. 1 and 3, the spine exercise apparatus according to the preferred embodiment of the present invention includes a base plate 10 which supports the body of a user, a support unit 13 which protrudes upwards from an upper surface of the base plate 10, a plate drive unit 36 which provides power to the base plate 10 to operate it, and a control box 34 which creates a drive signal to control the plate drive unit 36.

The base plate 10 has an upper surface on which the body of the user is supported in a variety of postures. The base plate 10 can have multiple degrees of freedom when moving. For example, as shown in FIG. 1, the base plate 10 can have three degrees of freedom in which it rotates around the X-, Y- and Z-axes. The base plate 10 can also have three degrees of freedom in which it moves along the X-, Y- and Z-axes. Preferably, the base plate 10 has at least four degrees of freedom including rotation around the X- and Y-axes and movement along the X- and Y-axes.

Body contact units 11 are provided in the upper surface of the base plate 10 so that some parts of the body of the user come into contact with the body contact units 11. FIG. 2 is a sectional view showing an embodiment of the body contact unit 11.

Referring to FIG. 2, each body contact unit 11 is installed in a depression G which is formed in a predetermined portion of the upper surface of the base plate 10. The body contact unit 11 includes a contact plate 111, an elastic member 112 and a first load cell 113. A portion of the body of the user makes direct contact with and applies pressure to the contact plate 111. The elastic member 112 is interposed between the contact plate 111 and the base plate 10 and provides elastic force to the contact plate 111 and the base plate 10 so that they are spaced apart from each other by a predetermined distance. The first load cell 113 is disposed below the contact plate 111 and measures the pressure applied to the contact plate 111.

The first load cell 113 is a sensor which senses the pressure applied from the body of the user to the contact plate 111 and outputs an electrical signal. The first load cell 113 measures the pressure generated by a portion of the body of the user and provides it to the control box 34.

The support unit 13 is provided on the upper surface of the base plate 10 and is brought into contact with a portion of the body of the user supported on the base plate 10 so that the portion of the body can be supported by the support unit 13. As shown in FIG. 1, for example, the support unit 13 may support the abdomen of the user who is on his/her hands and knees. FIG. 3 is a view showing in detail the support unit 13 of the spine exercise apparatus of the embodiment of the present invention.

Referring to FIG. 3, the support unit 13 includes a lower support part 131 which is fixed at a lower end thereof to the upper surface of the base plate 10 and is shaped like a column, and an upper support part 132 which is provided on an upper end of the lower support part 131 and is operated in multiple degrees of freedom. For instance, as shown in FIG. 3, the upper support part 132 can have three degrees of freedom in which it rotates around the X-, Y- and Z-axes, and three degrees of freedom in which it moves along the X-, Y- and Z-axes. It is preferable that the upper support part 132 have at least four degrees of freedom of rotation around the X- and Y-axes and movement along the X- and Y-axes. The upper support part 132 is moved on an upper end of the lower support part 131 within an appropriate permissible range along the movement of the corresponding portion of the body of the user while it is pressed by the portion of the body.

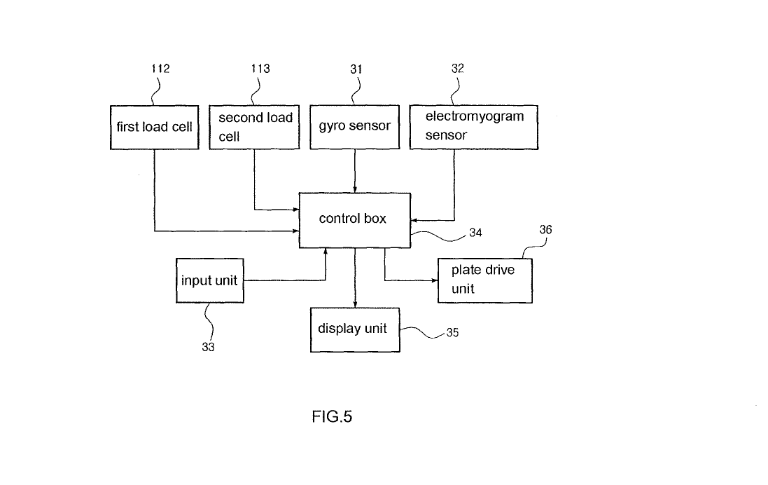

FIG. 4 is a sectional view of the support unit of the spine exercise apparatus of the embodiment of the present invention. Referring to FIG. 4, an elastic member 133 for providing elastic force and a second load cell 134 for sensing the pressure provided by a portion of the body of the user supported on the support unit are disposed at predetermined positions between the lower support part 131 and the upper support part 132.

The support unit 13 supports the weight of the user to reduce the load applied to the body of the user and enables the user to appropriately control his/her posture interlocked to the movement of the base plate 10. Further, the second load cell 134 that is provided in the support unit 13 measures the pressure applied from the corresponding portion of the body of the user to the support unit 13, thus calculating the center of gravity of the user's body.

The plate drive unit 36 provides power to the base plate 10 so that the base plate 10 can move in the given degrees of freedom. For example, the plate drive unit 36 can be embodied by at least some among a motor, an actuator and a link connection mechanism which can provide rotating force, such as a rolling or pitching force, and forward, rearward, leftward and rightward linear moving force to the base plate 10 that is placed substantially horizontally on the ground. Besides, a variety of power supply devices known in the art can be used as the plate drive unit 36, and there is a huge number of kinds of power supply devices. Therefore, detailed explanation of these will be skipped.

The spine exercise apparatus according to the present invention further includes an electromyogram sensor 32 which is attached to the erector muscle of spine of the user's body supported on the base plate 10 and measures information about movement of the erector muscle of spine, and a gyro sensor 31 which is attached to the base plate 10 to sense a direction and degree in which the base plate 10 is tilted.

Signals created by the above-stated several measurement devices are transmitted to the control box 34. Based on information contained in the signals, the control box 34 creates a drive signal to operate the base plate 10 and transmits the drive signal to the plate drive unit 36 or obtains information about the balance of the user's body, in other words, determines conditions of the spine.

The spine exercise apparatus according to the present invention further includes a display unit 35 which visually displays information about conditions of the spine obtained from signals created by several measurement devices, or contents such as a biofeedback game so that the user can enjoy the spine exercise. The control box 34 also controls the operation of the display unit 35.

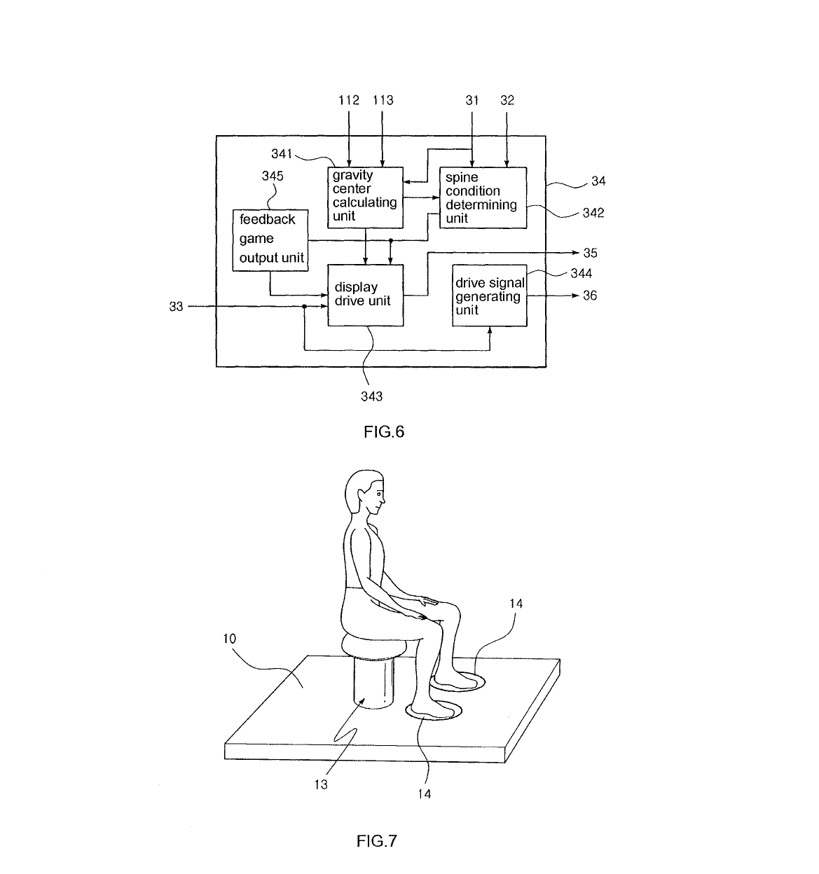

FIG. 6 is a block diagram showing in detail the construction of the control box 34 of the spine exercise apparatus of the embodiment of the present invention.

Referring to FIG. 6, the control box 34 includes a gravity center calculating unit 341 and a spine condition determining unit 342. The gravity center calculating unit 341 uses pressures measured by the first load cells 113 and the second load cell 134 and calculates the center of gravity of the user's body. The spine condition determining unit 342 uses the center of gravity of the user's body calculated by the gravity center calculating unit 341, the information about movement of the erector muscle of the spine sensed by the electromyogram sensor 32, and the direction and degree, in which the base plate 10 is tilted, sensed by the gyro sensor 31, and calculates information about conditions of the spine of the user, in other words, information about the balance of the user's body.

The control box 34 further includes a feedback game output unit 345 which provides, using the display unit 35, a biofeedback game interlocked to the movement of the base plate 10 operated by the plate drive unit 36 depending on the information about conditions of the spine determined by the spine condition determining unit 342.

FIG. 7 is a perspective view illustrating a spine exercise apparatus according to another embodiment of the present invention.

The spine exercise apparatus according to the embodiment of FIG. 1 includes the four body contact units 11 and 12 which come into contact with the hands and knees of the user and support them on the base plate 10 so that a variety of kinds of measurement and movement can be conducted while the user is on his/her hands and knees. In this case, because the user is on his/her hands and knees, the support unit 13 supports the abdomen of the user's body.

On the other hand, the spine exercise apparatus according to the embodiment of FIG. 7 includes two body contact units 14 which come into contact with the feet of the user while the user is in a sitting posture in which the hips of the user are on the support unit 13.

Hereinafter, the operation and effect of the spine exercise apparatus according to the present invention having the above-mentioned construction will be explained in detail with reference to the attached drawings.

As shown in FIG. 1 or 7, the user brings portions of his/her body into contact with the body contact units 11, 12, 14 of the base plate 10 and places his/her body on the support unit 13 in a posture in which the user is on his/her hands and knees or sits. Then, the first load cells 113 which are provided in the body contact units 11, 12, 14 measure the pressure applied from the corresponding contact portions of the user's body to the body contact units 11, 12, 14. The second load cell 134 which is provided in the support unit 13 measures the pressure applied to the support unit 13 from the abdomen of the user when on his/her hands and knees or from the hips of the user when sitting on the support unit 13.

The gravity center calculating unit 341 of the control box 34 calculates the center of gravity of the user's body using the pressures measured by the first and second load cells 113 and 134. That is, the gravity center calculating unit 341 calculates pressure distribution on different portions of the user's body depending on locations at which the load cells 113 and 134 are disposed, and then calculates the center of gravity of the user's body using the calculated pressure distribution.

The center of gravity of the user's body that is calculated by the gravity center calculating unit 341 is transmitted to the spine condition determining unit 342. The spine condition determining unit 342 obtains information about the balance of the user's body based on the location of the center of gravity and the pressure distribution. For example, if the center of gravity of the user's body or the pressure distribution is towards a specific portion of the user's body, it can be shown that the spine is curved or there is a problem with a specific portion of the erector muscle that supports the spine. Determination of the spine condition determining unit 342 with regard to conditions of the spine can be embodied by a program produced based on a variety of clinical experience and data.

Preferably, in an embodiment, the electromyogram sensor 32 can be attached to each of at least two portions of the user's body to sense a bio signal of the erector muscle that supports the spine. Bio signals, containing information about muscular strength of the erector muscle of spine, sensed by the electromyogram sensors 32 are output as electrical signals. Given locations at which the electromyogram sensors 32 are attached to the user's body and the relative distribution of bio signals output from the locations, conditions of the erector muscle of spine can be obtained. Particularly, the conditions of the erector muscle of the spine can be determined in more detail by analyzing signals of the electromyogram sensors 32 in response to the direction, in which the base plate 10 is tilted, sensed by the gyro sensor 31.

The determination of the conditions of the erector muscle of the spine can also be conducted based on a variety of clinical experience and data. The spine condition determining unit 342 can be embodied by a program produced based on clinical experiences and data.

Information about the conditions of the spine or the erector muscle of the spine obtained by the spine condition determining unit 342 is transmitted to a display drive unit 343. The display drive unit 343 operates the display unit 35 and visually indicates the information about the conditions of the spine or the erector muscle of spine.

Meanwhile, based on the information about the conditions of the spine or the erector muscle of the spine, the spine exercise apparatus can be set such that the base plate 10 is operated in an appropriate manner. For instance, if a patient who has pain in his/her spine is on the base plate 10, information about the conditions of the spine or the erector muscle of the spine obtained by different kinds of measurements is displayed on the display unit 35. Based on this information, a doctor inputs an order to an input unit 33 and operates the base plate 10 so that the spine of the patient can be appropriately exercised.

Then, as the base plate 10 moves, the posture of the patient who is supported on the base plate 10 changes. To maintain a steady posture, the patient who is on the base plate 10 applies strain to his/her body in a corresponding direction. Repetition of this can correct a crooked spine or exercise the erector muscle of spine. Particularly, depending on conditions of the spine analyzed by information about the center of gravity or electromyographic signals, the base plate repetitively tilts in an appropriate direction and destabilizes the posture so that a specific portion of the spine can be strengthened. As such, the present invention makes it possible to deliver intensive care to a specific portion of the spine.

Furthermore, in the present invention, contents such as the biofeedback game may be provided by the display unit 35 so that the patient who is performing the spine training exercise on the base plate 10 can relieve boredom and enjoy the exercise. This biofeedback game can be provided by the feedback game output unit 345 of the control box 34. For instance, a biofeedback game may be provided in such a way that a race or scoring game is conducted in interlock with the magnitudes of signals output from the electromyogram sensors attached to the patient. This continuously rouses the interest in the spine training exercise and motivates the patient to conduct the exercise, so that not only can the effects of the exercise be enhanced but the patient can also easily recognize the conditions of his/her own muscular strength from a pace or record in the game, thus helping the patient actively carry out the exercise or treatment.

As described above, in an embodiment of a spine exercise apparatus according to the present invention, a patient can actively perform a spine training exercise or treatment not only in an upright posture but also in a posture in which the patient is on his/her hands and knees. Therefore, the spine exercise apparatus can be applied to all patients who have pain in their spines regardless of the extent of symptoms. Furthermore, in an embodiment, the spine exercise apparatus includes a support unit which supports a portion of the patient's body (e.g. the abdomen or hips). Thus, distribution of pressures transmitted from the patient's body can be checked more precisely. In addition, the support unit offers additional support to the patient's body so that the load applied to the spine during the spine training exercise can be reduced. Moreover, the spine training exercise or treatment using the spine exercise apparatus according to the present invention can substitute for spinal surgery, thus reducing time expense or financial cost for the patient.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A spine exercise apparatus, comprising:
a base plate provided with a plurality of body contact units coming into contact with portions of a body of a user, the base plate having an upper surface supporting the body of the user while the body contact units come into contact with the portions of the body of the user;
a support unit protruding from the upper surface of the base plate, the support unit supporting another portion of the body of the user;
a plate drive unit supplying power to the plate so that the plate moves in a plurality of degrees of freedom; and
a control box creating a plate drive signal containing information about the power to be supplied by the plate drive unit and providing the plate drive signal to the plate drive unit.

2. The spine exercise apparatus as set forth in claim 1, wherein each of the body contact units comprises a first load cell sensing a pressure applied from the corresponding portion of the body of the user that is brought into contact with the respective body contact unit.

3. The spine exercise apparatus as set forth in claim 2, wherein the support unit comprises:
a lower support part protruding from the upper surface of the base plate;
an upper support part provided on an upper end of the lower support part, the upper support part having a plurality of degrees of freedom; and
a second load cell sensing a pressure applied from the portion of the body of the user that is supported by the upper support part.

4. The spine exercise apparatus as set forth in claim 3, wherein the control box comprises
a gravity center calculating unit calculating a center of gravity of the body of the user using the pressures sensed by the first load cells and the second load cell.

5. The spine exercise apparatus as set forth in claim 4, further comprising
an electromyogram sensor attached to an erector muscle of the spine of the body of the user that is supported on the upper surface of the base plate, the electromyogram sensor sensing information about movement of the erector muscle of spine.

6. The spine exercise apparatus as set forth in claim 5, wherein the control box further comprises
a gyro sensor attached to the base plate to sense a direction and degree in which the base plate is tilted.

7. The spine exercise apparatus as set forth in claim 6, further comprising:
a spine condition determining unit determining information about conditions of the spine of the body of the user using the center of gravity of the body calculated by the gravity center calculating unit, the information about movement of the erector muscle of the spine sensed by the electromyogram sensor, and the direction and degree, in which the base plate is tilted, sensed by the gyro sensor.

8. The spine exercise apparatus as set forth in claim 7, further comprising
a display unit displaying the information about the conditions of the spine determined by the spine condition determining unit.

9. The spine exercise apparatus as set forth in claim 8, wherein the control box further comprises
a feedback game output unit providing, using the display unit, a biofeedback game interlocked to the movement of the base plate operated by the plate drive unit depending on the information about the conditions of the spine determined by the spine condition determining unit.

10. The spine exercise apparatus as set forth in claim 1, wherein the body contact units comprise four body contact units coming into contact with hands and knees of the user such that the body of the user is supported on the base plate in a posture in which the user is on the hands and knees, and
the support unit supports an abdomen of the user who is on the hands and knees.

11. The spine exercise apparatus as set forth in claim 1, wherein the support unit supports hips of the user who is in a sitting posture, and
the body contact unit comprises two body contact units coming into contact with feet of the user so that the feet of the user who is sitting on the support unit are supported on the respective body contact units.

12. The spine exercise apparatus as set forth in claim 3, wherein the plate drive unit provides power to the base plate so that the base plate is operated in four degrees of freedom, and
the upper support part has four degrees of freedom.
